(19) United States
(12) Patent Application Publication
(10) Pub. No.: US 2009/0080932 A1
(43) Pub. Date: Mar. 26, 2009

(54) TONER CARTRIDGE, IMAGE FORMING APPARATUS PROVIDED WITH THE SAME, AND METHOD OF RECYCLING TONER CARTRIDGE

(76) Inventor: Shinya MIMURA, Nara-shi (JP)

Correspondence Address: NIXON & VANDERHYE, PC, 901 NORTH GLEBE ROAD, 11TH FLOOR, ARLINGTON, VA, 22203, US

(21) Appl. No.: 12/202,564

(22) Filed: Sep. 2, 2008

(30) Foreign Application Priority Data
Sep. 26, 2007 (JP) 2007-249432

(51) Int. Cl. G03G 15/00

(52) U.S. Cl. 399/109

(57) ABSTRACT

A toner cartridge comprising: a toner storage container with a toner discharge port, including a plurality of container component members, and a toner discharging unit for discharging toner stored in the toner storage container outside through the toner discharge port, wherein the plurality of container component members are mutually joined by an electrically-peeling adhesive whose adhesion force is reduced by electrification.

### CROSS-REFERENCE TO RELATED APPLICATION

This application is related to Japanese patent application No. 2007-249432, filed on Sep. 26, 2007 whose priority is claimed under 35 USC §119, the disclosure of which is incorporated by reference in its entirety.

### BACKGROUND OF THE INVENTION

1. Field of the Invention

The present invention relates to a toner cartridge, an image forming apparatus provided with the same, and a method of recycling a toner cartridge.

2. Description of the Related Art

An image forming apparatus that forms an image by utilizing an electrophotographic system is often used in a copying machine, a printer, a facsimile machine or the like and in widespread use because of its ability of forming a high quality image with a simple operation and of its easy maintenance. An image forming apparatus of a general electrophotographic system includes mainly a photoconductor drum for forming an electrostatic latent image, a developing device for developing the electrostatic latent image, a transferring device for transferring a toner image to paper, and a fuser for fixing the toner image on the paper.

Toner and paper that are consumed can be replenished by an user when they are run out, however, since toner is made of very light and fine particles, toner may disperse in air or soil a user's hand when it is supplied to the image forming apparatus. Therefore, in recent years, it becomes a mainstream to directly replace a toner cartridge storing toner so that toner particles will not disperse in the air, namely to remove a vacant toner cartridge from an image forming apparatus, and attach a new toner cartridge.

A conventional toner cartridge has a toner storage container that is formed by joining a container main body with an wide opening serving as an inlet for charging toner inside the container, and a lid member for lidding the opening of the container main body by an adhesive without forming any gap, and a toner discharge port serving as an outlet of toner is provided in a part of the toner storage container. Inside the toner storage container, a toner discharging unit is provided that discharges toner stored inside through the toner discharge port while the toner is stirred. Such a conventional toner cartridge is disclosed, for example, in Japanese patent Application Laid-Open Publication No. 2004-286849.

With recent increasing awareness of environmental issues, a used toner cartridge is often recycled rather than being disposed, and is shipped again after cleaning and charging with new toner. However, since a toner cartridge contains toner made of such fine particles as having particle diameters of several micrometers, it is necessary to strictly seal so as to prevent the toner from leaking from the toner cartridge due to vibration during transportation on a ship, an automobile or the like. To achieve this, a container main body and a lid member of a toner cartridge are securely joined without leaving no gap by an adhesive as described above. This complicates operations of disassembly and cleaning, and replacement of consumable parts, and such toner cartridges are often disposed because they cannot be recycled due to breakage and the like.

### SUMMARY OF THE INVENTION

The present invention provides a toner cartridge that is less toner leakage during transportation in which it is subjected to a vibration for a long time, and has excellent recyclability, and an image forming apparatus using the same, and provides a method of recycling a toner cartridge with excellent operability.

According to the present invention, there is provided a toner cartridge including a toner storage container with a toner discharge port, including a plurality of container component members, and a toner discharging unit for discharging toner stored in the toner storage container outside through the toner discharge port, in which the plurality of container component members are mutually joined by an electrically-peeling adhesive whose adhesion force is reduced by electric current.

Further, according to another aspect of the present invention, there is provided an image forming apparatus including a photoconductor drum having a surface on which an electrostatic latent image is to be formed; a charging device that charges the surface of the photoconductor drum; a light exposure device that forms an electrostatic latent image on the charged surface of the photoconductor drum; a developing device that forms a toner image by making toner adhere to the electrostatic latent image on the surface of the photoconductor drum; the toner cartridge that supplies the developing device with toner; a transferring device that transfers the toner image on the surface of the photoconductor drum to a recording medium; a cleaning device that cleans the surface of the photoconductor drum; and a fuser that fixes the toner image on the recording medium.

According to another aspect of the present invention, there is provided a method of recycling a toner cartridge, including a step (1) of making an electric current flow in the electrically-peeling adhesive to reduce adhesion force of the electrically-peeling adhesive, and a step (2) of peeling off the electrically-peeling adhesive having reduced adhesion force from the plurality of container component members to disassemble the toner storage container.

According to the toner cartridge of the present invention, since the container component members that constitute the toner storage container are joined by the electrically-peeling adhesive, such air-tightness is realized that prevents toner from leaking even under vibration during transportation. Further, since the used toner cartridge can be readily disassembled because adhesion force of the electrically-peeling adhesive is reduced by making an electric current flow therein, disassembling is facilitated, a breakage rate in the disassembling is reduced, and internal cleaning and replacement of consumable parts are facilitated. This provides excellent recyclability.

Further, according to the method of recycling a toner cartridge of the present invention, it is possible to readily disassemble the toner cartridge only by making an electric current flow in the electrically-peeling adhesive, so that breakage in the disassembling is reduced, and a recycling rate can be improved.

Further, according to the image forming apparatus having the toner cartridge of the present invention, an environment-friendly image forming apparatus can be obtained because of excellent recyclability of the toner cartridge.

### BRIEF DESCRIPTION OF THE DRAWINGS

FIG. 1 is a section view, viewed from a front side, schematically showing a configuration of a first embodiment of a toner cartridge of the present invention;

FIG. 2 is a conceptual view showing a condition that an alternating current is caused to flow in an electrically-peeling adhesive of the toner cartridge of the first embodiment;

FIG. 3 is a conceptual view showing a condition of disassembling the toner cartridge of the first embodiment;

FIG. 4 is a section view, viewed from a front side, schematically showing a configuration of a third embodiment of a toner cartridge of the present invention;

FIG. 5 is an enlarged section view a vicinity of a joint area, showing a condition that an alternating current is caused to flow in an electrically-peeling adhesive of the toner cartridge of the third embodiment;

FIG. 6 is a section view, viewed from a front side, schematically showing an outline structure of an image forming apparatus having the toner cartridge of the first embodiment; and

FIG. 7 is an enlarged section view showing a vicinity of the toner cartridge of the image forming apparatus in FIG. 6.

### DETAILED DESCRIPTION OF THE INVENTION

### (Description of Toner Cartridge)

The toner cartridge of the present invention includes a toner storage container with a toner discharge port, including a plurality of container component members, and a toner discharging unit for discharging toner stored in the toner storage container outside through the toner discharge port, in which the plurality of container component members are mutually joined by an electrically-peeling adhesive whose adhesion force is reduced by electric current.

The toner cartridge of the present invention is replaceably attached to OA equipment of an electrophotographic system such as a copying machine, a printer, a facsimile machine or the like, and an appearance form, a size and the like thereof are not particularly limited, and may be appropriately designed in accordance with the OA equipment.

In the present invention, the electrically-peeling adhesive is an adhesive that contains a composition that is electrochemically debondable, and by generating a debonding reaction upon electrification, reduces adhesion force of a joining face (interface) in the electrically-peeling adhesive that is in contact with an object to be adhered.

The electrically-peeling adhesive in the present invention may be produced, for example, by a method described in Published Japanese translation of a PCT application No. 2003-504504, or commercially available. As a commercially available product of the electrically-peeling adhesive, for example, Electrelease (trade name) available from EIC Laboratories, Inc. (epoxy-based adhesive) can be recited.

This electrically-peeling adhesive has a debondable function at a positive interface between an object to be adhered which is electrically connected with a positive electrode, and the electrically-peeling adhesive, as well as a debondable function at a negative interface between an object to be adhered which is electrically connected with a negative electrode, and the electrically-peeling adhesive. Further, the electrically-peeling adhesive preferably has thermosettability.

In the present invention, a thickness of the electrically-peeling adhesive joining between the container component members may be such a thickness that ensures adhesion force with which joining will not be broken by physical external force by impact during transportation or the like, and will not cause running off the electrically-peeling adhesive from a joint area. For example, about 200 to 500 μm is appropriate.

In the present invention, each of the container component members that constitute the toner storage container may be molded of a resin material having excellent design flexibility, and as such a resin material, for example, an ABS (acrylonitrile-butadiene-styrene) resin, a PS (polystyrene) resin, a PC (polycarbonate) resin and the like can be recited, and among these, an ABS resin is preferred because of its excellent impact resistance, resistance to staining and applicability of a wide variety of forming methods including injection, extrusion, blowing and the like moldings.

These resin materials generally have such a volume specific resistance (volume resistivity) of as high as 10¹² Ω·cm or higher. Therefore, when a voltage is applied while output terminals of positive and negative electrodes of a power unit are brought into contact with a joint area of two container component members that are joined each other with an electrically-peeling adhesive, at the time of electrifying the electrically-peeling adhesive, it becomes difficult to debond the electrically-peeling adhesive.

For addressing to this, in a plurality of container component members, such a configuration is preferably employed that at least a joint area contacting with the electrically-peeling adhesive has conductivity. When such a configuration is employed, container component members on both sides of the electrically-peeling adhesive serve as electrodes, so that it becomes easy to make an electric current flow in the electrically-peeling adhesive, and it is possible to securely peel off the electrically-peeling adhesive without any residue on the container component members.

As a configuration in which at least a joint area contacting with the electrically-peeling adhesive in a container component member has conductivity, the following (1) and (2) may be employed.

(1) The plurality of container component members are made of a conductive resin material in which a conductive material is dispersed and mixed in a resin. In this case, the conductive material may be contained at least in the joint area of the container component member, however, the conductive material may be contained in the entire container component member. When conductivity is imparted only to a neighborhood of the joint area of the container component members, for example, a resin in which a conductive material is dispersed and mixed is used in the neighborhood of the joint area of the container component members, while a resin in which a conductive material is not mixed is used in a remaining part to form the container component member. At this time, a method of forming a container component member by integrally molding a part having conductivity and a part not having conductivity, or a method of forming a container component member by separately molding the part having conductivity and the part not having conductivity, and integrating them by an adhesive not having electric debondability may be employed.

According to the configuration (1), since at least the part contacting with the electrically-peeling adhesive in the container component member has conductivity, flexibility of electrode contact to be brought into contact in application of a voltage to the toner cartridge increases, so that an electrification operation is further facilitated. Further, it is possible to apply a stable voltage to the electrically-peeling adhesive, and to peel off the electrically-peeling adhesive by reducing adhesion force at a low voltage.

(2) In the plurality of container component members, a joint area contacting with the electrically-peeling adhesive is covered with a metal plate. According to this configuration (2), since a metal plate exposed from a joint area of container component members serves as an electrode, flexibility of electrode contact to be brought into contact in application of a voltage to the toner cartridge increases, and hence an electrification operation is further facilitated. Additionally, since the electrically-peeling adhesive is in contact with the metal plate, it is possible to apply a further stable voltage to the electrically-peeling adhesive, and to peel off the electrically-peeling adhesive by reducing adhesion force at a further low voltage.

In the above configuration (1), examples of the conductive material include, but are not limited to, carbon black, metal powder or metal oxide powder (e.g., aluminum, titanium oxide or the like), and a mixture thereof. Among these, carbon black is preferred for a reason that it lowers resistance of a resin material by addition of a small amount, and will not lower the strength of the container component member.

It is preferred that carbon black having an average primary particle size of 10 to 500 nm is dispersed and mixed in a conductive resin in a proportion of 5% by weight or more and 20% by weight or less. When the adding amount of the carbon black is less than 5% by weight, conductivity is difficult to be obtained, whereas when the adding amount is more than 20% by weight, the resin strength tends to decrease.

In the above configuration (2), a metal material of the metal plate is not particularly limited as far as it has conductivity, and for example, aluminum, SUS (stainless steel) and the like can be recited, and among these, SUS is preferred for its strength and strong corrosion resistance. A thickness of the metal plate is appropriately about 100 to 300 μm, and a preferred width is such a dimension that is able to cover an end edge of the joint area of the container component member, and a more preferred width is such a dimension that is able to ensure electrode contact as the metal plate goes around the outer face of the joint area (for example, about 1 to 5 mm). Further, the metal plate can be adhered by an adhesive to an end edge of the joint area of the container component member to be along a longitudinal direction. As the adhesive, one that will not reduce adhesion force by electrification is used.

In the present invention, the number of container component members (parts number) that constitute a toner storage container in a disassemblable manner is not particularly limited, however, smaller number is more preferred from the view points of easiness of assembling and disassembling of the toner storage container and cost reduction, and it is desired that the toner storage container includes two container component members. In this case, for example, among the two container component members, one is designed as a container main body having a later-described toner discharging unit incorporated therein, and an opening for charging of toner, while the other is designed as a lid member for lidding the opening of the container main body, and the electrically-peeling adhesive is applied along the circumferential part of the opening of the container main body, and the lid member is fixedly attached to the container main body. Such a configuration is preferred in that replenishment of toner and replacement of consumable parts in assembling and recycling of a toner cartridge can be readily conducted, and is advantageous as a structural body in which a toner discharge port is provided and a toner discharging unit is integrated in a part of a wall part of a container main body.

In the present invention, a configuration of the toner discharging unit is not particularly limited, however, a simple configuration that allows quantitative discharge of toner through the toner discharge port at the time of driving is preferred. A concrete configuration will be described later.

### (Description of Method of Recycling Toner Cartridge)

The toner cartridge having the above configuration may be recycled by a recycling method that includes a step of making an electric current flow in the electrically-peeling adhesive to reduce adhesion force of the electrically-peeling adhesive (1), and a step of peeling off the electrically-peeling adhesive having reduced adhesion force from the plurality of container component members to disassemble the toner storage container (2).

According to this method of recycling a toner cartridge, since it is possible to readily disassemble the toner cartridge by making an electric current flow in the electrically-peeling adhesive, it is possible to improve the recycling efficiency by avoiding breakage at the time of disassembling, facilitate internal cleaning and replacement of consumable part, and enable recycling of toner cartridge with excellent operability.

When the step (1) is conducted, a predetermined voltage is applied while the output terminals of the positive and negative electrodes of the power unit are in contact with the neighborhood of the joint area of the container component members on both sides of the electrically-peeling adhesive. At this time, in disassembling two container component members adhered by an electrically-peeling adhesive having a debondable function of the positive interface or the negative interface, the electric current is preferably an alternating current. By using the AC, it is possible to simultaneously debond the electrically-peeling adhesive and the container component members on both sides, so that in the step (2), the electrically-peeling adhesive can be readily and completely peeled off from both of the container component members. As a result, working efficiency in rebonding of the container component members is improved.

On the other hand, when a direct current is caused to flow in the joining face of the electrically-peeling adhesive, debonding occurs only on one adhesive face, so that the electrically-peeling adhesive remains on the other of the container component member. In this case, bonding of an interface may be released by applying voltage again to the other of the container component member and the electrically-peeling adhesive while the polarities are reversed.

When the toner storage container includes three or more container component members, the above step (1) may be repeated until the container component members are disassembled individually, however, all of the container component members are not necessarily disassembled insofar as the replenishment of toner is satisfactorily conducted and unnecessity of replacement of parts can be checked.

Further, the step (1) is conducted at an application voltage and an application time that are necessary for debonding of the electrically-peeling adhesive.

The electric current necessary for debonding the electrically-peeling adhesive is about 10⁻³ amperes per square centimeter, and the voltage required therefor is at most several volts to several tens volts, however, in order to cancel the volume specific resistance (in particular, resistance in the neighborhood of the joint area) possessed by the toner storage container, the voltage of about several hundreds volts may sometimes be required.

In consideration of safety in the electrification operation, and prevention of damage to the container component members, a lower application voltage is preferred, and in consideration of the operability, the shorter application time is preferred. Therefore, the application voltage and the application time may be reduced by the container component member of the above configuration (1) or (2) in which the joint area with the electrically-peeling adhesive has conductivity.

In the case of the configuration (1), the application voltage in the step (1) is about 10 to 50 volts, and the application time is about 10 to 60 seconds, and in the case of the configuration (2), the application voltage in the step (1) is about 10 to 30 volts, and the application time is about 10 to 30 seconds. Further, when the container component member does not have the configuration (1) or the configuration (2), the required application voltage in the step (1) is about 10 to 100 volts, and the required application time is about 1 to 5 minutes.

### (Description of Image Forming Apparatus Having Toner Cartridge)

The toner cartridge as described above may be provided in an image forming apparatus having the following configuration. To be more specific, the image forming apparatus includes a photoconductor drum having a surface on which an electrostatic latent image is to be formed; a charging device that charges the surface of the photoconductor drum; a light exposure device that forms an electrostatic latent image on the charged surface of the photoconductor drum; a developing device that forms a toner image by making toner adhere to the electrostatic latent image on the surface of the photoconductor drum; the toner cartridge that supplies the developing device with toner; a transferring device that transfers the toner image on the surface of the photoconductor drum to a recording medium; a cleaning device that cleans the surface of the photoconductor drum; and a fuser that fixes the toner image on the recording medium.

This image forming apparatus is applicable to a copying machine, a printer, a facsimile machine and the like having at least the above configuration, and when it is applied in a copying machine, in addition to the above configuration, a scanner unit for reading a document, a document conveyer for conveying a document to the scanner unit, a paper feed cassette for supplying a recording medium to the developing device, a manual paper feed tray for arbitrarily supplying a desired recording medium to the developing device; a paper discharge tray for receiving a recording medium on which toner image is transferred and the like may be provided.

Hereinafter, embodiments of the present invention will be explained in detail with reference to attached drawings.

### First Embodiment of Toner Cartridge

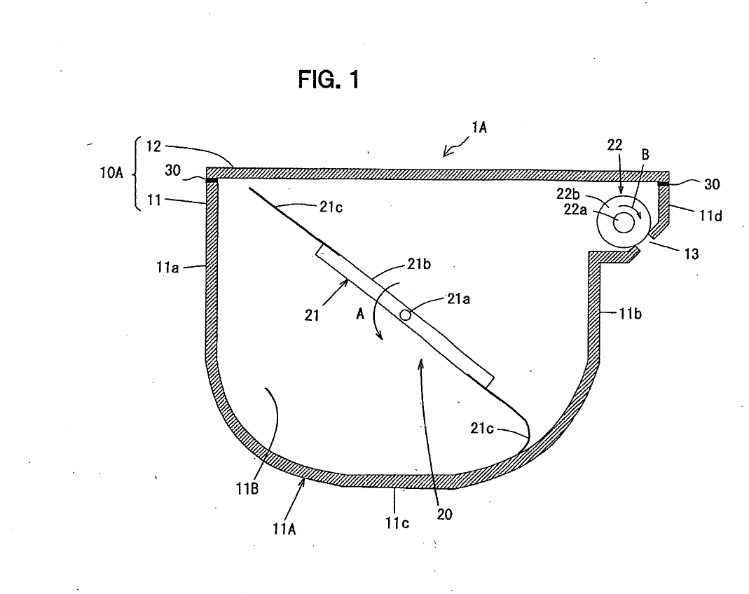

FIG. 1 is a section view, viewed from a front side, schematically showing a configuration of a first embodiment of a toner cartridge of the present invention.

As shown in FIG. 1, a toner cartridge 1A has a toner storage container 10A, and a toner discharging unit 20 provided inside the toner storage container 10A.

The toner storage container 10A has a container main body 11 which is a constituent of the container, and a lid member 12 which is another constituent of the container, and has an appearance of a generally rectangular parallelepiped with a rounded bottom.

The container main body 11 is a container with a rectangular upper opening, including a trunk forming wall 11A extending longitudinally and having a flat left side wall 11a, a flat right side wall 11b, a bottom wall 11c formed in a rounded manner in continuation with the left side wall 11a and the right side wall 11b, and a projecting wall 11d provided to project outwardly at an upper end of the right side wall 11b, and a front wall (omitted in the drawing) and a rear wall 11B that block front and back openings of the trunk forming wall 11A that are formed integrally of an ABS resin. An upper opening edge of the container main body 11 defined by the left side wall 11a, the projecting wall 11d, the front wall and the rear wall 11B is a continuous flat face aligned at the same level.

The projecting wall 11d has an upper end that is aligned at the same level with the left side wall 11a, and has a slant wall part between the upper end and the lower end, and a rectangular toner discharge port 13 is formed in a part of the slant wall part. The toner discharge port 13 is formed in such a position that it faces with a developing device of an image forming apparatus when the toner cartridge 1A is attached to the image forming apparatus (not illustrated).

The lid member 12 is a flat molded plate made of an ABS resin, formed to have substantially the same outer profile as an outer profile of the upper opening edge of the container main body 11. The lid member 12 provides a hermetical seal that prevents toner from leaking out of the container main body 11 by being bonded by an electrically-peeling adhesive 30 as described above in the part along the upper opening edge of the container main body 11. The electrically-peeling adhesive 30 in an un-solidified state having fluidity is laminated together with the container main body 11 and the lid member 12 and then solidified by heating at 80 to 100° C. for 60 to 90 minutes to join the container main body 11 and the lid member 12.

The toner discharging unit 20 has a toner pumping mechanism 21 and a toner discharging mechanism 22.

The toner pumping mechanism 21 has a rotation shaft 21a made of stainless steel, disposed in a substantially center point of the front wall and the rear wall 11B of the toner storage container 10A and having both ends pivoted in a rotatable manner, a rectangular toner stirring plate 21b having a center of a short side in a width direction fixed to the rotation shaft 21a, and a pair of rectangular toner pumping blades 21c attached along both ends in the width direction of the toner stirring plate 21b. The toner pumping blade 21c has flexibility, and is a plastic sheet of, for example, polyethylene terephthalate (PET), polypropylene or the like, having a thickness of about 0.5 to 2 mm.

The toner discharging mechanism 22 has a rotation shaft 22a made of stainless steel, pivoted in a rotatable manner in the vicinity of the projecting wall 11d in the front wall and the rear wall 11B of the toner storage container 10A, and a toner discharge roller 22b fixed to the rotation shaft 22a.

The toner discharge roller 22b is formed by winding a porous elastic body of foam ester-based polyurethane foam (so-called sponge-like) around the rotation shaft 22a, and blocks the toner discharge port 13 from the inside of the toner storage container 10A, and discharges toner through the toner discharge port 13 in association with rotation of the rotation shaft 22a.

By forming a superficial layer of a foam elastic body having elasticity as the toner discharge roller 22b, it is possible to convey toner with high efficiency when the toner cartridge 1A is attached in the image forming apparatus (in use condition). As a material of foam elastic body, polyurethane, silicone rubber, EPDM or the like is used, and in particular, from the view points of durability and toner conveyability, a polyurethane foam body is preferred.

In the toner discharging unit 20 thus configured, the toner stored in the toner storage container 10A is stirred by the toner stirring member 21b rotating in the direction of an arrow A about the rotation shaft 21a, while the toner pumping blade 21c pumps the toner in the toner storage container 10A and conveys it to the toner discharge roller 22b. Further, the toner discharge roller 22b reversely rotates in the direction of an arrow B, thereby supplying the toner conveyed by the toner pumping blade 21c from the toner discharge port 13 to a developing tank 51 of an image forming apparatus P (see FIG. 7).

The rotation shaft 21a for rotating the toner stirring member 21b and the rotation shaft 22a for rotating the toner discharge roller 22b are configured to rotate simultaneously in opposite directions by driving force from a gear transmission mechanism (not shown) provided outside the rear wall 11B of the toner storage container 10A and a driving motor provided in the image forming apparatus to which the toner cartridge 1A is attached. Further, the driving motor drives in response to a signal from a controlling unit as will described later provided in the image forming apparatus to rotate the toner discharge roller 22b and the toner stirring member 21b.

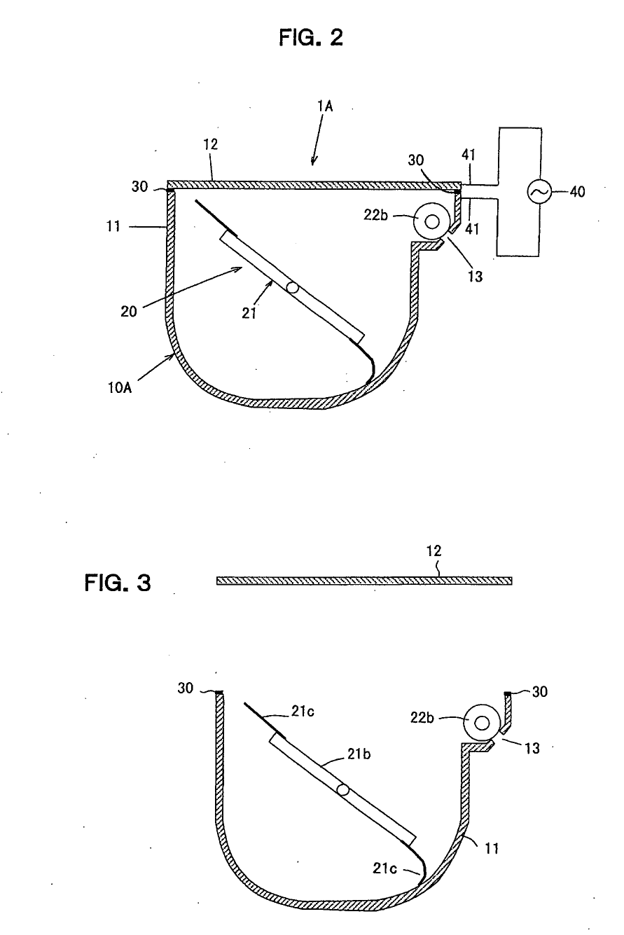

For disassembling the toner cartridge 1A after use, as shown in FIG. 2, a pair of output terminals 41, 41 of an AC power unit 40 are brought into contact with the neighborhood of the joint area between the container main body 11 and the lid member 12 sandwiching the electrically-peeling adhesive 30, and a voltage is applied by the AC power unit 40 to make an alternating current of about 10⁻³ A/cm² flow in the electrically-peeling adhesive 30. As a result, adhesion force of the electrically-peeling adhesive 30 with respect to the container main body 11 and the lid member 12 is weakened, so that the container main body 11 and the lid member 12 can be disassembled as shown in FIG. 3. At this time, voltage application is conducted, for example, at 50 volts for 2 minutes in consideration of operability, safety, and prevention of damage on the toner storage container 10A.

In this manner, since disassembling is allowed by simply making an electric current flow in the joint area between the container main body 11 and the lid member 12 joined by the electrically-peeling adhesive 30, it is possible to improve the recycling efficiency by avoiding breakage at the time of disassembling, to facilitate internal cleaning and replacement of consumable parts, and to enable recycling of a toner cartridge with excellent operability.

In recycling, after conducting replacement of consumable parts and replenishment of toner, the electrically-peeling adhesive 30 in an un-solidified state having fluidity is applied along the top face of the upper opening edge of the container main body 11, and an outer circumferential edge of the inner face of the lid member 12 is placed on the electrically-peeling adhesive 30 under an appropriate pressure, and the electrically-peeling adhesive 30 is caused to solidify by heating at 80 to 100° C. for 60 to 90 minutes, whereby the container main body 11 and the lid member 12 are joined with each other.

### Second Embodiment of Toner Cartridge

A toner cartridge of a second embodiment (not illustrated) has the same structure as that of the first embodiment, but is different in that the container main body and the lid member constituting the toner storage container have entirely conductivity by the structure (1) as described above. Specifically, in the second embodiment, the entire container main body and the entire lid member are formed of an ABS resin in which carbon black having an average primary particle diameter of about 80 nm is evenly dispersed in an amount of about 15% by weight.

Also in the case of this toner cartridge, it is possible to disassemble the toner storage container by reducing the adhesion force of the electrically-peeling adhesive with respect to the container main body and the lid member by making an alternating current of about 10⁻³ A/cm² flow therein by application of a voltage to the neighborhood of the joint area between the container main body and the lid member in the same manner as in the first embodiment. In this case, voltage application may be conducted, for example, at 30 volts for 30 seconds.

### Third Embodiment of Toner Cartridge

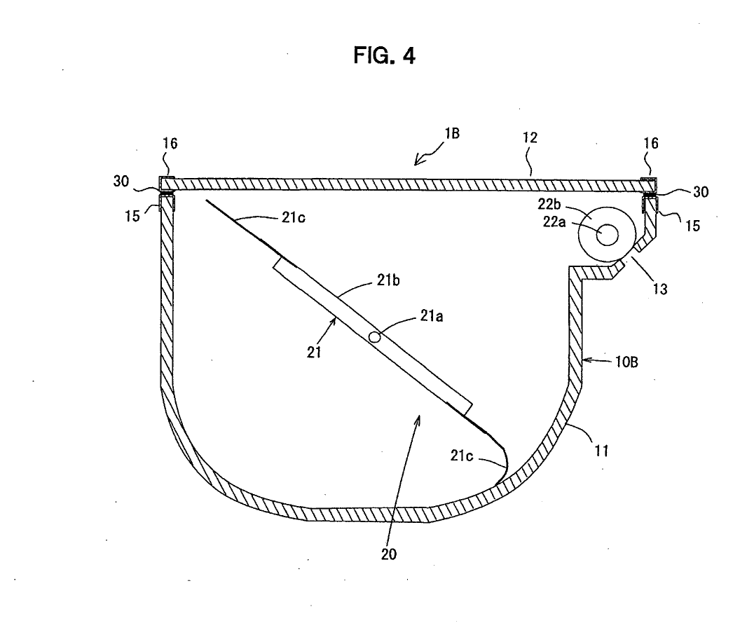

FIGS. 4 is a section view, viewed from a front side, schematically showing a configuration of a third embodiment of a toner cartridge of the present invention. In FIG. 4, an equivalent element as that in the first embodiment shown in FIGS. 1 to 3 is denoted by the same reference numeral.

In a toner cartridge 1B according to the third embodiment, the container main body 11 and the lid member 12 constituting the toner storage container 10B have conductivity in the neighborhood of the joint area by the configuration (2) as described above. Specifically, in the toner cartridge 1B according to the third embodiment, the container main body 11 and the lid member 12 are covered with metal plates 15, 16, in the neighborhood of their joint area, and other configuration is as same as that of the first embodiment.

In the following, description will be made mainly for the point that is different in the third embodiment from in the first embodiment.

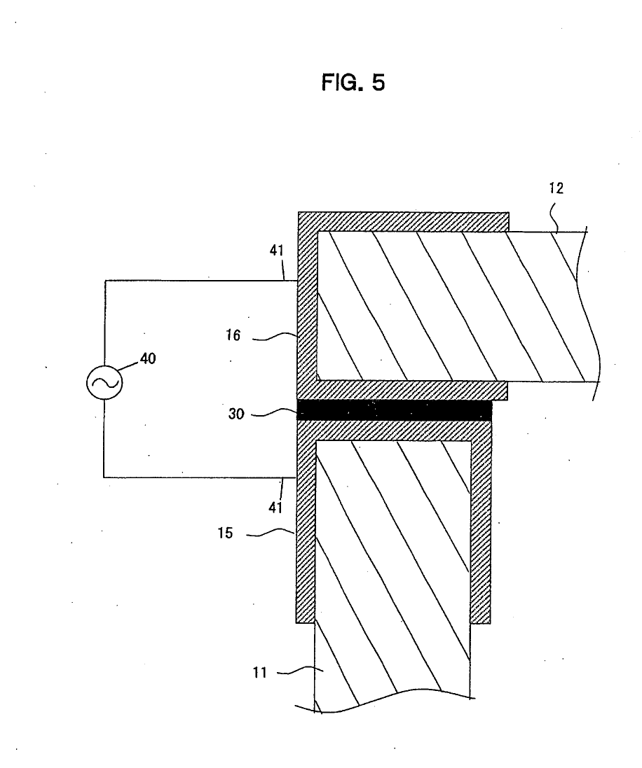

In this toner cartridge 1B, as shown in FIGS. 4 and 5, the electrically-peeling adhesive 30 bonds the container main body 11 and the lid member 12 via the metal plate 15 provided along the upper opening edge of the container main body 11, and the metal plate 16 provided along the outer circumferential edge of the lid member 12.

The metal plate 15 and the metal plate 16 are formed by bending a SUS plate having a thickness of about 200 μm so that the cross section has a squared U-shape, and are fixed by an adhesive so that they envelop the upper opening edge of the container main body 11 and the outer circumferential edge of the lid member 12. This adhesive is a commonly used adhesive not having electrically-peeling property, and for example, a thermosettable epoxy resin-based adhesive is used.

By forming the metal plates 15, 16 to have a cross section of squared U-shape, it is possible to prevent the metal plates 15, 16 from peeing off the container main body 11 and the lid member 12, so that the toner cartridge 1B having excellent durability against repeated recycling can be obtained. Further, since the metal plates 15, 16 exposed on the surface of the toner cartridge 1B function as electrodes for application of a voltage, it becomes easier to apply a voltage on the exposed parts of the metal plates 15, 16 in disassembling, and a voltage can be stably applied on the electrically-peeling adhesive 30 because the electrically-peeling adhesive 30 is in contact with the metal plates 15, 16, and hence the joint area may be peeled off with a low voltage.

For disassembling the toner cartridge 1B after use, as shown in FIG. 5, a pair of the output terminals 41, 41 of the AC power unit 40 are brought into contact with the metal plate 15 on a container main body 11 side and the metal plate 16 on a lid member 12 side sandwiching the electrically-peeling adhesive 30, and a voltage is applied by the AC power unit 40 to make an alternating current of about 10⁻³ A/cm² flow in the electrically-peeling adhesive 30. As a result, adhesion force of the electrically-peeling adhesive 30 with respect to the metal plates 15, 16 is weakened, so that the container main body 11 and the lid member 12 can be disassembled (see FIG. 3). At this time, voltage application is conducted, for example, at 15 volts for 20 seconds in consideration of operability, safety, and prevention of damage on the toner storage container 10B.

### Embodiment of Image Forming Apparatus

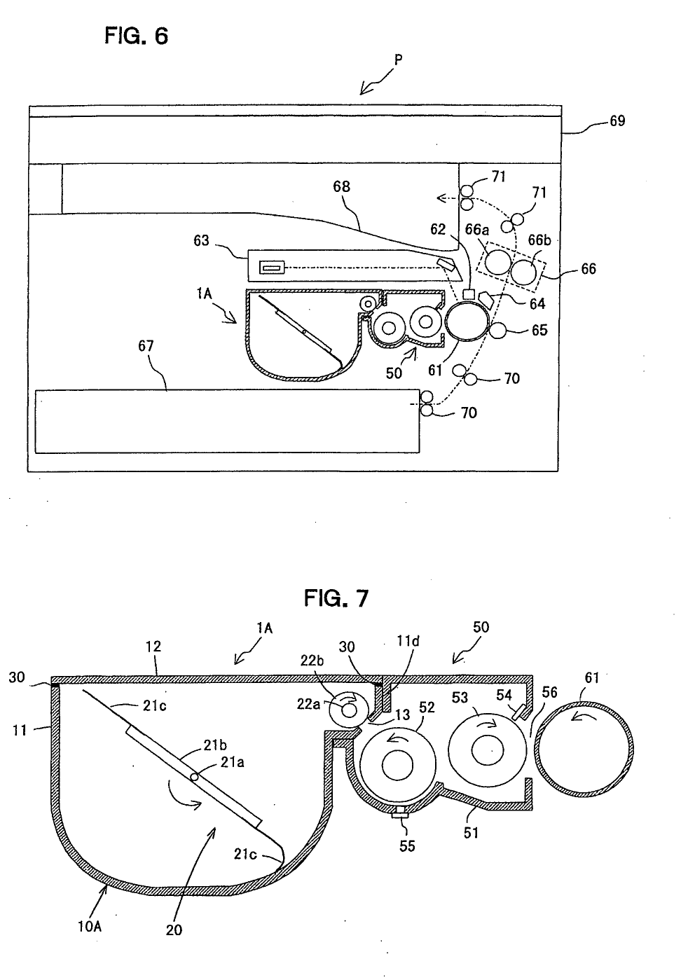

FIG. 6 is a section view, viewed from a front face of the image forming apparatus to which the toner cartridge of the first embodiment is attached, and FIG. 7 is an enlarged section view showing the vicinity of the toner cartridge of the image forming apparatus of FIG. 6.

The image forming apparatus P has the toner cartridge 1A, a developing device 50, a photoconductor drum 61, a charging device 62, a light exposure device 63, a cleaning device 64, a transferring device 65, a fuser 66, a paper feed cassette 67, a paper discharge tray 68, and a scanner unit 69.

The developing device 50 has a developing tank 51, a stirring roller 52, a developing roller 53, a restricting member 54 and a toner concentration detecting sensor 55.

The developing tank 51 is a cylindrical container member having an internal space, and supports the stirring roller 52 and the developing roller 53 in a rotatable manner, while containing a two-component developing agent composed of toner and a carrier. The developing tank 51 has a first opening in the form of recess, that communicates with the toner discharge port 13 while overlapping with the projecting wall 11d of the toner cartridge 1A attached inside a casing of the image forming apparatus P, and a second opening 56 at a position opposing to the photoconductor drum 61. Inside the developing tank 51, the stirring roller 52 is rotatably disposed on the side of the first opening, and the developing roller 53 is rotatably disposed on the side of the second opening.

The stirring roller 52 is rotationally driven by a driving unit (not illustrated), to stir the two-component developing agent contained in the developing tank 51.

The developing roller 53 conveys the two-component developing agent to the photoconductor drum 61, and is a roller-like member which is rotationally driven about the axial center by a driving unit (not illustrated). Further, the developing roller 53 is provided so that it is opposite to the photoconductor drum 61 through the second opening 56 of the developing tank 51, and is away from the photoconductor drum 61 with a certain interval.

The two-component developing agent conveyed by the developing roller 53 comes into contact with the photoconductor drum 61 at the closest position. This contact region is a developing nip part. In the developing nip part, a developing bias voltage is applied to the developing roller 53 from a power unit (not illustrated) connected with the developing roller 53, and toner is supplied from the developing agent on a surface of the developing roller 53 to an electrostatic latent image on the surface of the photoconductor drum 61.

The restricting member 54 is a rectangular plate-like member having a pair of long sides extending parallel with the axial direction of the developing roller 53 and a pair of short sides extending in the direction perpendicular to the axial direction, in which an end edge of one long side is attached to an inside upper edge of the second opening 56 of the developing tank 51, while an end edge of the other long side is adjacent to an outer circumferential face of the developing roller 53 with a slight interval. As a material of the restricting member 54, stainless steel may be used, however, aluminum, a synthetic resin and the like may also be used.

The toner concentration detecting sensor 55 is attached in the bottom face of the developing tank 51 and below in the vertical direction of the stirring roller 52, and is disposed so that the sensor face is exposed inside the developing tank 51. The toner concentration detecting sensor 55 is electrically connected with a controlling unit (not illustrated).

The controlling unit controls in such a manner that it rotationally drives the toner discharge roller 22b of the toner cartridge 1A according to a detection result by the toner concentration detecting sensor 55, and supplies toner to inside of the developing tank 51 through the toner discharge port 13.

The controlling unit sends a control signal to a driving unit that rotationally drives the toner discharge roller 22b, when it determines that the detection result from the toner concentration detecting sensor 55 is lower than a set value of toner concentration, and rotationally drives the toner discharge roller 22b.

Examples of the toner concentration detecting sensor 55 include, but are not limited to, a transmitted beam detecting sensor, a reflected light detecting sensor, and a permeability detecting sensor, and among these, a permeability detecting sensor is preferred in the present invention. In the following, description will be made for the case where the toner concentration detecting sensor 55 is a magnetic permeability detecting sensor in the present invention, and the reference numeral 55 in FIGS. 6 and 7 denotes a magnetic permeability detecting sensor.

To the magnetic permeability detecting sensor 55, a power unit (not illustrated) is connected. The power unit applies a drive voltage for driving the magnetic permeability detecting sensor 55 and a control voltage for outputting a detection result of toner concentration to the controlling unit, to the magnetic permeability detecting sensor 55. Application of a voltage to the magnetic permeability detecting sensor 55 by the power unit is controlled by the controlling unit. The magnetic permeability detecting sensor 55 is a sensor of the type that outputs, in response to application of a control voltage, a detection result of toner concentration as an output voltage value, and is used while such a control voltage that gives an output voltage situated basically at or around a center value of the output voltage is applied because excellent sensitivity is realized in such situation. The magnetic permeability detecting sensor 55 of such a type is commercially available, and for example, TS-L, TS-A, TS-K and so on (trade name) available from TDK Corporation can be used.

The photoconductor drum 61 is a roller-shaped member that is supported inside a casing of the image forming apparatus P in such a manner that it can be rotationally driven by a driving unit (not illustrated) about the axial line, and has a surface on which electrostatic latent image and toner image are sequentially formed. As the photoconductor drum 61, for example, a roller-shaped member in which a photoconductive layer is overlaid on a surface of a conductive base body (not illustrated) may be used. As such a conductive base body, cylindrical, columnar, sheet-like and the like conductive base bodies can be used, and among these, a cylindrical conductive base body is preferred. As a photoconductive layer, an organic photoconductive layer, an inorganic photoconductive layer and the like can be exemplified.

As an organic photoconductive layer, a laminate photoconductor of a charge generation layer which is a resin layer containing a charge generation substance, and a charge transport layer which is a resin layer containing a charge transport substance, or a monolayer photoconductor containing a charge generation substance and a charge transport substance in a single resin layer can be recited.

As an inorganic photoconductive layer, a film containing one or two or more kinds selected from zinc oxide, selenium, amorphous silicon and the like can be exemplified.

In the photoconductor drum 61, a backing film may be interposed between the conductive base body and the photoconductive layer, and a superficial film (protective film) may be provided on a surface of the photoconductive layer, principally for the purpose of surface protection.

The charging device 62 is a saw-tooth type charger that executes corona discharge on the photoconductor drum 61. To the charging device 62, a power unit (not illustrated) for applying voltage is connected. The charging device 62 makes the surface of the photoconductor drum 61 be charged at a predetermined voltage in a predetermined polarity in response to application of voltage from the power unit. As the charging device 62, contact-type chargers such as a charger-type charger, a charging brush-type charger, a roller-shaped charger, a magnetic brush and the like may be used besides the saw-tooth type charger.

The light exposure device 63 receives image information of a document read by the scanner unit 69 or image information from an external device inputted thereto, and irradiates the surface of the photoconductor drum 61 in charged state with a light signal in correspondence with the image information. As a result, an electrostatic latent image in correspondence with the image information is formed on the surface of the photoconductor drum 61.

As the light exposure device 63, a laser scanning device including a light source is used. The laser scanning device includes combination of, for example, a light source, polygon mirror, fθ lens, reflection mirror and the like. As a light source, for example, a semiconductor laser, LED array, electroluminescence (EL) device and the like may be used.

The transferring device 65 is a roller member that is provided inside a casing of the image forming apparatus P so that it is rotatable by a supporting member and a driving unit (not illustrated), and arranged in press-contact with the surface of the photoconductor drum 61 via a recording medium. As the transferring device 65, for example, a roller-shaped member in which a conductive elastic member is overlaid on a surface of a metal cored bar of 8 to 10 mm in a diameter may be used.

As the metal that forms the metal cored bar, stainless steel, aluminum and the like may be used. As a conductive elastic layer, rubber materials in which a conductive material such as carbon black is blended in a rubber material such as ethylene-propylene rubber (EPDM), EPDM foam and urethane foam may be used.

A recording medium is supplied one by one from the paper feed cassette 67 to a press-contact part (transferring nip part) between the photoconductor drum 61 and the transferring device 65 via a paper feed roller 70, in synchronization with conveyance of toner image by rotation of the photoconductor drum 61.

As the recording medium passes through the transferring nip part, toner image on the surface of the photoconductor drum 61 is transferred to the recording medium. To the transferring device 65, a power unit (not illustrated) is connected, and a voltage having an opposite polarity to the polarity of charge of toner forming the toner image is applied to the transferring device 65, in transferring of the toner image to the recording medium. As a result, the toner image is smoothly transferred to the recording medium.

The cleaning device 64 has a cleaning blade and a toner reservoir tank which are not illustrated. The cleaning blade is a rectangular elastic plate member disposed to extend in parallel with the longitudinal direction of the photoconductor drum 61, and one end of its long side is attached along an opening of the toner reservoir tank so that the other end of the long side abuts on the surface of the photoconductor drum 61. The cleaning blade removes toner, paper powder and the like remaining on the surface of the photoconductor drum 61 after transferring of toner image to the recording medium. The toner reservoir tank is a container-shape member having internal space, into which the toner removed by the cleaning blade is introduced through the opening and temporally reserved. By the cleaning device 64, the surface of the photoconductor drum 61 after transferring of toner image is cleaned.

The fuser 66 has a fuser roller 66a, and a pressurizing roller 66b. The fuser roller 66a is a roller-shaped member provided so that it is rotatable about axial line by a supporting member and a driving unit (not illustrated).

The fuser roller 66a has a heating member (not illustrated) inside the same, and heats the toner forming unfixed toner image carried by the recording medium conveyed from the transferring nip part, to make the image melt and be fixed on the recording medium. As the fuser roller 66a, for example, a roller-shaped member in which a cored bar is covered with an elastic layer may be used. The cored bar is formed of metal such as iron, stainless, aluminum and the like. The elastic layer is formed of an elastic material such as silicone rubber, fluorine rubber or the like. The heating member generates heat in response to application of a voltage from a power unit (not illustrated), and may be implemented, for example, by a halogen lamp, an infrared ray lamp and so on.

The pressurizing roller 66b is a roller-shaped member that is rotatably supported inside a casing, and provided to press-contact with the fuser roller 66a by a pressuring member (not illustrated), and is driven in association with rotation of the fuser roller 66a. The press-contact part between the fuser roller 66a and the pressurizing roller 66b is a fixing nip part. In heat fixing of a toner image onto a recording medium by the fuser roller 66a, the pressurizing roller 66b promotes fixing of a toner image onto the recording medium by pressing toner in melt condition against the recording medium. As the pressurizing roller 66b, a roller-shaped member having the same configuration as the fuser roller 66a may be used, and a heating member may further be provided inside. As the heating member, the one similar to the heating member inside the fuser roller 66a may be used.

The recording medium onto which a toner image has been transferred passes through the fixing nip part of the fuser 66. As a result, the toner forming the toner image is melt and pressed against the recording medium, so that the toner image is fixed onto the recording medium. The recording medium onto which image is printed is then discharged to the paper discharge tray 68 via a paper discharge roller 71.

The paper feed cassette 67 is a tray for storing recording medium such as plain paper, coated paper, paper for color copy, an OHP film and the like. On the downstream side of paper conveyance of the paper feed cassette 67, a pickup roller and a conveyance roller (not illustrated) are provided, and a recording medium is supplied one by one to the transferring nip part by the pickup roller and the conveyance roller in synchronization with that the toner image on the surface of the photoconductor drum 17 is conveyed to the transferring nip part.

A scanner unit 31 has a document set tray, a RADF (Reversing Automatic Document Feeder) and a document reader which are not illustrated.

An automatic document feeder feeds a document placed on the document set tray to a document platen belonging to the document reader.

The document reader has a document platen, a document scanner, a reflecting member, a charge coupled device (hereinafter, referred to as “CCD”) line sensor and so on, and reads image information of the document placed on the document platen every plural lines, for example, every 10 lines.

The document platen is a glass plate member provided for placement of a document from which image information is to be read.

The image scanner has a light source and a first reflection mirror (not illustrated), and reciprocally moves parallel along a lower face in the horizontal direction of the document platen at a constant velocity V, and irradiates an image surface of the document placed on the document platen with light. A reflected light image is obtained by irradiation with light. The light source is a light source of light for irradiating a document placed on the document platen. The first reflection mirror reflects a reflected light image toward the reflecting member. The reflecting member has a second reflection mirror, a third reflection mirror and an optical lens (not illustrated), and focuses the reflected light image obtained by the document scanner on the CCD line sensor. The reflecting member reciprocally moves following reciprocal movement of the document scanner at a velocity of V/2. The second and the third reflection mirrors reflect a reflected light image so that the reflected light image is directed to an optical lens. The optical lens focuses the reflected light image on the CCD line sensor.

The CCD line sensor has a CCD circuit (not illustrated) for carrying out photoelectric conversion from the reflected light image focused by the optical lens into an electric signal, and outputs an electric signal that is image information to an image processor in the controlling unit. The image processor converts image information inputted from the document reader or from an external device such as personal computer into an electric signal, and outputs it to the light exposure device 63.

In FIG. 6 and FIG. 7, the image forming apparatus P having the toner cartridge 1A according to the first embodiment is exemplified, however, the toner cartridge according to the second embodiment or the third embodiment may be used in place of the toner cartridge 1A according to the first embodiment.

1. A toner cartridge comprising:
a toner storage container with a toner discharge port, including a plurality of container component members, and
a toner discharging unit for discharging toner stored in the toner storage container outside through the toner discharge port,
wherein the plurality of container component members are mutually joined by an electrically-peeling adhesive whose adhesion force is reduced by electrification.

2. The toner cartridge according to claim 1, wherein the electrically-peeling adhesive is an epoxy-based adhesive.

3. The toner cartridge according to claim 1, wherein of each of the plurality of container component members, a joint area contacting with the electrically-peeling adhesive has conductivity.

4. The toner cartridge according to claim 1, wherein the plurality of container component members are made of a conductive resin material in which a conductive material is dispersed and mixed in a resin.

5. The toner cartridge according to claim 4, wherein the conductive material is carbon black.

6. The toner cartridge according to claim 5, wherein the carbon black is mixed in a proportion of 5% by weight or more, and 20% by weight or less in the conductive resin material.

7. The toner cartridge according to claim 1, wherein of each of the plurality of container component members, a joint area contacting with the electrically-peeling adhesive is covered with a metal plate.

8. A method of recycling the toner cartridge according to claim 1, comprising the steps of:
(1) making electric current flow in the electrically-peeling adhesive to reduce adhesion force of the electrically-peeling adhesive, and
(2) peeling off the electrically-peeling adhesive having reduced adhesion force from the plurality of container component members to disassemble the toner storage container.

9. The method of recycling the toner cartridge according to claim 8, wherein the electric current in the step (1) is alternating current.

10. An image forming apparatus comprising a photoconductor drum having a surface on which an electrostatic latent image is to be formed; a charging device that charges the surface of the photoconductor drum; a light exposure device that forms an electrostatic latent image on the charged surface of the photoconductor drum; a developing device that forms a toner image by making toner adhere to the electrostatic latent image on the surface of the photoconductor drum; the toner cartridge according to claim 1 that supplies the developing device with toner; a transferring device that transfers the toner image on the surface of the photoconductor drum to a recording medium; a cleaning device that cleans the surface of the photoconductor drum; and a fuser that fixes the toner image on the recording medium.
